(19) United States
(12) Patent Application Publication
(10) Pub. No.: US 2016/0320512 A1
(43) Pub. Date: Nov. 3, 2016

(54) STRUCTURE DIP CONSTRAINED KIRCHHOFF MIGRATION

(71) Applicant: HALLIBURTON ENERGY SERVICES, INC., Houston, TX (US)

(72) Inventors: Xiaomin Zhao, Sugar Land, TX (US); Shengwen Jin, Sugar Land, TX (US)

(73) Assignee: Halliburton Energy Services, Inc., Houston, TX (US)

(21) Appl. No.: 14/780,701

(22) PCT Filed: Oct. 31, 2014
(86) PCT No.: PCT/US2014/063327

§ 371 Date: Sep. 28, 2015

(51) Int. Cl. G01V 1/48; G01V 1/36

(52) U.S. Cl. CPC G01V 1/48; G01V 1/362; G01V 2210/514; G01V 2210/1429

(57) ABSTRACT

Acquiring seismic input data and computing a structure tensor based on the seismic input data to determine seismic orientation data for one or more subsurface geological features. Kirchhoff migration is applied to the seismic input data and constrained with the seismic orientation data derived from the structure tensor. A seismic depth image based on the Kirchhoff migration as constrained by the structure tensor is then generated for consideration.

### BACKGROUND

In surface seismic exploration, energy imparted into the earth by a seismic source reflects from subsurface geophysical features or structures and is recorded by a multiplicity of receivers called geophones that are strategically placed on the surface. In other applications, the receivers can be arranged within a borehole that penetrates one or more formations of interest. This process is repeated numerous times, using source and receiver configurations, which may either form a line (2-D acquisition) or cover an area (3D acquisition). The resulting data is processed to produce a seismic image of the subsurface geophysical features using a procedure known as migration.

Following migration, the obtained seismic images often suffer in spatial accuracy, resolution and coherence due to the long and complicated travel paths between source, reflector, and receiver. To overcome this difficulty, a technique known as vertical seismic profiling (VSP) is used to image the subsurface in the vicinity of a borehole. In conventional VSP, a surface seismic source is used at the surface and one or more downhole receivers are used to detect reflections from subsurface acoustic impedance contrast around the borehole. The VSP surveys are commonly utilized to image deep structures that surface seismic is unable to adequately reach, or used in areas where the complex geological structures cannot be properly imaged by conventional seismic surveys.

However, the VSP images are often limited to the near borehole region, and the quality of the images often suffers from far-field migration artifacts due to insufficient stacking power caused by limited acquisition geometry and coarse geophone distribution, etc. This problem can become more prominent in scenarios where only a small number of downhole receivers are deployed along the borehole. The coverage of seismic source locations on the surface is also very limited compared to surface seismic surveys. Therefore, it is usually difficult to properly image the down dip geological structures with conventional imaging techniques such as Kirchhoff migration, reverse time migration, full waveform inversion, etc.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is schematic diagram of a well system that may employ the principles of the present disclosure for improved vertical seismic profiling.

FIG. 2 is a schematic flowchart of an exemplary method of processing seismic data.

FIG. 3 is a HESS salt model made from synthetic seismic data.

FIGS. 4A and 4B show example shots and receiver gathers from finite difference synthetic modeling of the HESS salt model of FIG. 3.

FIG. 5 is a plot showing Kirchhoff migration of the shots and receiver gathers of FIGS. 4A and 4B

FIG. 6 is a plot showing the Kirchhoff migration of FIG. 5 with a conventional aperture limiting technique.

FIG. 7 shows raw Kirchhoff migration image with structure tensor constraint.

FIG. 8 shows the seismic image of FIG. 7 overlaid with the HESS salt model of FIG. 3.

FIG. 9 illustrates a block diagram of an exemplary system used to process received signals and data.

### DETAILED DESCRIPTION

The present disclosure is related to downhole seismic imaging and, more particularly, to improving vertical seismic profile techniques based on Kirchhoff migration with structure dip constraint information.

The embodiments described herein improve seismic image migration processing by incorporating structure dip information in the vertical seismic profiling migration process. As a result, borehole seismic data may be coherently stacked in an angular region around prominent subsurface geological features to reduce noise and migration artifacts and thereby enhance image quality. As described herein, structure dip information may be computed from raw vertical seismic profile images using a structure tensor analysis. The structure tensor analysis may determine the eigenvectors to form the structure tensor and obtain smoothed Gaussian derivatives of the seismic images. The tensor components yield structure dip information that may then be used to constrain the vertical seismic profiling migration process. In some embodiments, the vertical seismic profiling migration process may be undertaken in accordance with Kirchhoff migration processing.

As shown in the example provided below, vertical seismic profiling migration with structure dip constraint can significantly improve seismic image quality. Without the constraint, seismic data, which in many cases contain severe noise and other artifacts, for all angles are indiscriminately stacked and therefore provide poor image quality and generate migration artifacts, especially in the far borehole region. With the structure dip constraint, however, the data may be coherently stacked in a solid angular region around the subsurface geological features and the resulting seismic image quality is, therefore, generally improved.

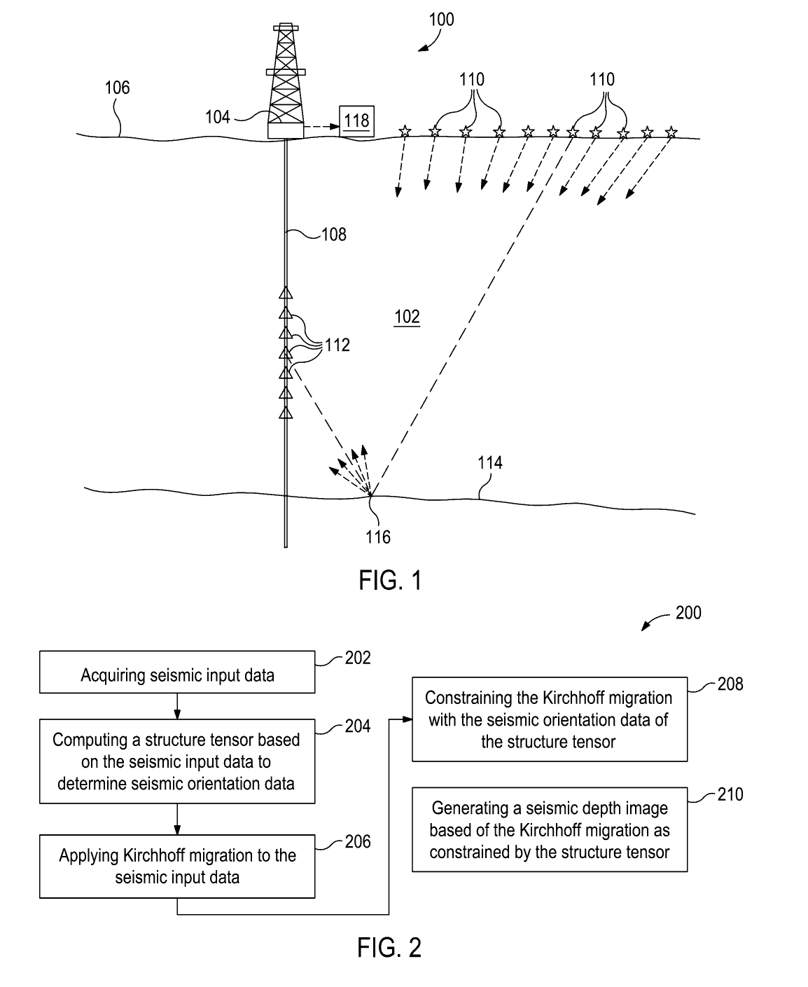

Referring to FIG. 1, illustrated is an exemplary well system 100 that may employ the principles of the present disclosure, according to one or more embodiments. As described in more detail below, the well system 100 may be used to map or profile various subsurface geological features 102. As illustrated, the well system 100 may include a wellhead installation 104 arranged at a surface 106 and a borehole 108 extending into the subsurface geological features 102. The well system 100 may be used in vertical seismic profiling (VSP) to image the subsurface geological features 102 in the vicinity of the borehole 108.

A plurality of seismic sources 110 may be arranged on the surface 106 to impart seismic energy into the Earth and, more particularly, into the subsurface geological features 102. The seismic sources 110 can be any type of vibration-generating devices or mechanisms such as, but not limited to, explosives and machines that generate vibration (e.g., VIBROSEIS® sources). When operating in a marine environment, the seismic sources 110 may comprise air guns or marine vibrators. A plurality of receivers 112, such as geophones or other seismic detection devices, may be positioned within the borehole 108 at predetermined locations to detect the seismic energy generated by the seismic sources 110. VSP data acquisition may be performed by conveying the receivers 112 downhole on a wireline after drilling of the borehole 108 has been partially or fully completed. VSP data acquisition may also be performed while drilling by conveying the receivers 112 downhole in an array forming part of a drilling bottom hole assembly (BHA). This practice is commonly referred to as VSP while drilling.

In operation, seismic signals may be generated by the seismic sources and may propagate into the subsurface geological features 102. The receivers 112 are able to detect reflections emanating from various subsurface impedance contrasts, such as one or more subsurface strata or geological features 114, at a plurality of reflection points 116. While only one reflection point 116 is depicted in FIG. 1 in association with one geological feature 114, it will be appreciated that several reflection points associated with several corresponding geological features 114 may be generated during operation of the seismic sources 110 to adequately obtain the desired VSP input data.

The receivers 112 detect the reflected seismic signals and generate corresponding output signals that may be transmitted to a computer 118. Here the computer 118 is depicted as being arranged at or near the surface 106 for processing. However, the computer 118 or one or more portions thereof (e.g. processors or memory) may be disposed downhole (e.g. in a tool disposed in the borehole 108). The computer 118 may be configured to generate multiple shot gathers and receiver gathers generated from the input data received by the receivers 112. In some cases, the computer 118 may be programmed and otherwise configured to stack the input data to produce a three-dimensional (3D) image of the subsurface geological features 102 away from the borehole 108. This may be done using a variety of imaging tools designed to map geological structures including, but not limited to, Kirchhoff migration, reverse time migration, full waveform inversion, etc. The resulting output is a stacked seismic image volume that may be output as a graphical representation of a seismic depth image corresponding to the subsurface geological features 102 in the vicinity of the borehole 108.

Kirchhoff migration imaging is a technique for migration processing in which a velocity model is calculated and thereby defined for various subsurface geological features 102. More particularly, Kirchhoff migration constitutes a method of seismic migration that uses an integral form of a wave equation, which is a mathematical expression that represents wave displacement potential function ψ and wave velocity V as functions of space (x,y,z) and time t. The wave equation is shown below as Equation (1):

$$\begin{matrix}{V}^{2} ψ = \frac{{\partial }^{2} ψ}{\partial {x}^{2}} + \frac{{\partial }^{2} ψ}{\partial {y}^{2}} + \frac{{\partial }^{2} ψ}{\partial {z}^{2}} \\ = ( \frac{1}{{V}^{2}} ) \frac{{\partial }^{2} ψ}{\partial {t}^{2}}\end{matrix} \qquad Equation ( 1 )$$

The integral of Equation (1) is known as the Kirchhoff equation or Kirchhoff integral. Kirchhoff migration is basically a summation of the amplitude along the diffraction curves that satisfies the seismic imaging principle. Below is a brief mathematical description:

I(X)=∫∫dsdrD(s,r,t=T(s,X)+T(X,r)) Equation (2)

where I is the depth image; X is the 3D image point (x,y,z); s is the source (or shot) location (i.e., s(x,y,z); r is the receiver location (i.e., r(x,y,z); and t is the recording time on the data, where T(s,X) and T(X,r) is the travel time from source to the image point, and from the image point to receiver, respectively.

Methods of seismic migration involve the back-propagation (or continuation) of the seismic data or “wavefield” from the region where it was measured (e.g., the borehole 108) and into the region to be imaged (e.g., subsurface geological features 102). In Kirchhoff migration, this is done by using the Kirchhoff integral representation of a wavefield at a given point (e.g., the reflection point 116) as a (weighted) superposition of waves propagating from adjacent points and times. Continuation of the wavefield requires a background model of seismic velocity, which is usually a model of constant or smoothly varying velocity. Travel times are computed from the seismic sources 110 to the reflection point(s) 116, and from the reflection point(s) 116 to the receivers 112. The actual image of a reflector is then obtained by combining data from a plurality of source-receiver pairs to a plurality of imaging points. If the velocity model is reasonably accurate, the signals will interfere constructively at the correct image point. Because of the integral form of Kirchhoff migration, its implementation reduces to stacking the data along curves that trace the arrival time of energy scattered by image points in the Earth.

Although other advanced imaging techniques have emerged in recent years, Kirchhoff migration (also termed prestack Kirchhoff depth migration) is one of the more common methods used in borehole seismic imaging, not only as a result of its fast computing performance as compared to other migration techniques, but also for its ability to image high frequency wavefields with little or no extra cost. This is crucially important for reconstructing high-resolution subsurface geological features 102 such as thin geological layers, faults, local dips, etc. However, there are some fundamental limitations and shortcomings in Kirchhoff migration processing. For example, with a limited number of surface seismic sources 110 and/or downhole receivers 112, it is often difficult to distinguish the migration artifacts (e.g., migration swings) and far field signals. Some techniques used in conjunction with Kirchhoff migration, such as aperture limiting and source/receiver weighting, may help in certain applications but may not be adequate to obtain an optimum image for the entire region of interest with complex subsurface geological features 102.

According to embodiments of the present disclosure, VSP Kirchhoff migration processing may be combined with structure dip information derived from structure tensor analysis, as generally disclosed in Jin, et al., 2014, “Structure tensor constrained tomographic migration velocity analysis,” 84th SEG Conference, the contents of which are hereby incorporated by reference. By employing structure tensor constraints in combination with VSP Kirchhoff migration, it may be possible to improve the quality of the resulting seismic image where dip structures are more accurately imaged away from the borehole 108.

A three-dimensional (3D) structure tensor is a matrix derived from the gradient of a function, which represents the predominant directions of the gradient in a specified neighborhood of a point. According to the present disclosure, Kirchhoff migration processing may be constrained by computing and applying a structure tensor derived from seismic data input to determine the orientation of subsurface geological features 102. In some embodiments, the seismic input data may comprise a stacked seismic image volume, which may be derived and otherwise obtained by any migration algorithm from the surface seismic surveys, as generally described above. In other embodiments, the input data to the structure tensor computation may comprise a 3D velocity model including tomographic model or synthetic velocity data corresponding to a particular geological formation or region.

The structure tensor computed from the seismic data input carries various information pertaining to the subsurface geological features 102, such as local dip attributes and magnitudes, reflection and azimuth angles, etc. Structure dip information of the seismic data can be estimated from the structure tensor, and such structure dip information may then be extracted from the multi-component structure tensor and used as a constraint in the Kirchhoff migration processing.

Enhancing and locating the subsurface geological features 102 using a first-order structure tensor is now described. Structure analysis of a 3D dataset, such as the seismic data, originates with image processing where the structure of a two-dimensional (2D) image is represented as gradients, edges, or similar types of information. This translates to 3D data where gradients, edges, curvature, and other image elements can be represented in three-dimensions. This information is gained by calculating derivatives and partial derivatives, and then analyzing the vector representation of magnitude changes of pixel (or voxel in 3D) values. In two-dimensions the orientation of maximum change in an image corresponds to Equation (3) below, where Iₓ is the partial derivative of image I in the x-direction, and I_{y} is the partial derivative in the y-direction:

$$\begin{matrix}\vert g \vert = \sqrt{{I}_{x}^{2} - {I}_{y}^{2}} & Equation ( 3 ) \\ θ = {tan}^{- 1} ( \frac{{I}_{y}}{{I}_{x}} ) \\ {I}_{x} = \frac{\partial I}{\partial x} \\ {I}_{y} = \frac{\partial I}{\partial y} & Equation ( 4 )\end{matrix}$$

The vector resulting from this is directed according to the ordering of pixel points (high to low values or low to high values) and points along the orientation of the angle θ, which varies from [0,π] with a magnitude given by g. The calculation of the Iₓ and I_{y} partial derivatives in Equation (4) can be accomplished using standard central differences between neighboring pixels (voxels) or more robustly by convolving neighboring voxels with a Gaussian mask over a range of voxels and then taking the difference of the Gaussian-smoothed neighbors.

The orientation of seismic strata are generally not horizontal (parallel to the ground plane), which means filtering techniques used on seismic data images must take into account local orientations, otherwise undesired blurring across horizons will inevitably result, as in the case of mean and median filtering. To measure the orientation of seismic strata from the seismic data, gradient structure tensor may be used. For a local neighborhood I(x,y,z) in a 3D image, the gradient structure tensor can be given by Equation (5) below:

$$Gradient Structure Tensor = [ \begin{matrix}{I}_{x}^{2} & {I}_{x} {I}_{y} & {I}_{x} {I}_{z} \\ {I}_{x} {I}_{y} & {I}_{y}^{2} & {I}_{y} {I}_{y} \\ {I}_{x} {I}_{z} & {I}_{y} {I}_{y} & {I}_{z}^{2}\end{matrix} ] \qquad Equation ( 5 )$$

Since the gradient structure tensor represents an orientation rather than a direction, this formulation allows the blurring of tensors in a way that lets vectors pointing in opposite directions to support an orientation rather than counteract each other. In addition, the gradient structure tensor constitutes a 3×3 positive semi-definite matrix, which is invariant to Gaussian convolution.

Using Gaussian convolution to average the tensors creates a more robust representation of the orientation field. The eigenanalysis of the structure tensor provides information about the local orientation and coherence of the seismic strata based on the seismic data. The corresponding eigenvectors define a local coordinate axis while the associated eigenvalues provide or otherwise describe the local coherence, which represents the strength of the gradient along the respective eigenvectors. The dominant eigenvector represents the direction of the gradient orthogonal to the seismic strata, while the smaller two eigenvectors form an orthogonal plane parallel to the seismic strata. Near faults or other discontinuities in the data may affect the strength of the dominant eigenvector before Gaussian smoothing and therefore are not sufficient to confidently define a plane orthogonal to the seismic strata. However, after Gaussian smoothing of the tensors, a more confident eigenstructure is represented at faults and discontinuities that more accurately represents the true orientation. The orientation of the respective eigenvectors provides a robust estimate of the local orientation at each point in the seismic image.

After removing noise in the seismic data by conducting anisotropic smoothing along stratigraphic layers, the result is a new stacked seismic image volume with attenuated noise and enhanced features. Structure analysis may then be used to extract information that may be useful in identifying data features, such as orientation data of one or more subsurface geological features 102 (FIG. 1). First, a more robust representation of the orientation field given by the structure tensor may be computed using Gaussian convolution, which averages the tensor orientations. Next, the eigenanalysis of the smoothed structure tensor can be computed to provide the local orientations as well as indications of singularities in the data volume. In accordance with the representation of the gradient structure tensor, three real eigenvalues and eigenvectors can be found. The eigenvectors define a local coordinate axis while the eigenvalues describe the local coherence, which represents the strength of the gradient along each respective eigenvector. Potential critical points are located in the data volume by using the three-dimensional gradient magnitude, as provided by Equation (6) below:

|∇I|=\sqrt{Iₓ²+I_{y}²+I_{z}²} Equation (6)

It is believed that structure tensor dip constraints applied to VSP Kirchhoff migration can significantly improve seismic image quality as compared to conventional aperture limiting methods. Without the structure tensor dip constraint, migrated seismic data for all angles, which in many cases contain severe noise and other artifacts, may be indiscriminately stacked. As can be appreciated, this often produces poor seismic image quality and generates migration artifacts, especially in the far borehole region. With the structure tensor dip constraint, however, seismic data may be coherently stacked in a favorable angle region around the given structure dip, which generally improves the seismic image quality.

Referring now to FIG. 2, with continued reference to FIG. 1, illustrated is a schematic flowchart of an exemplary method 200 of processing seismic data, according to embodiments of the present disclosure. According to the method 200, seismic input data may first be acquired, as at 202. The seismic input data may comprise one or both of a stacked seismic image volume or a 3D velocity model corresponding to synthetic data. The seismic input data may be received and processed by a computer, such as the computer 118 of FIG. 1. In embodiments where the seismic input data is a stacked seismic image volume, the seismic input data may be obtained through the operation of the system 100 and its several components, as generally described above with reference to FIG. 1.

A structure tensor may then be computed from the seismic input data to determine seismic orientation data for one or more subsurface geological features, as at 204. More particularly, the structure tensor may be computed and processed on the computer 118 (FIG. 1) in view of one or both of the stacked seismic image volume or the 3D velocity model, each of which contains seismic data corresponding to the subsurface geological features 102 (FIG. 1). The computer 118 may be programmed to carry out this function either autonomously or when prompted by a user. This computation or analysis may be configured to obtain smoothed Gaussian derivatives of the seismic input data and determine the eigenvectors to form the structure tensor, which yields the structure orientation data. For the eigenvectors, the associated eigenvalues may be used to weigh the orientation data of the subsurface geological features. An eigenvalue threshold is determined, above which the orientation information is robust and reliable, below which the data are associated with low-amplitude, non-coherent noises and may, therefore, be weighted down or otherwise eliminated.

Kirchhoff migration may then be applied to the seismic input data to reconstruct images of the subsurface geological features 102 as based on the seismic input data, as at 206. In the Kirchhoff migration process, travel time is computed from source to the reflection point on a geological structure and to the receiver locations. The computation is done only for valid dip angle range from the orientation data. The computer 118 may also be programmed to undertake the Kirchhoff migration processing and otherwise migrate or back-propagate the seismic input data to provide a seismic image representative of the subsurface geological features 102. The Kirchhoff migration may be constrained with the seismic orientation data derived from the structure tensor, as at 208. In other words, the computer 118 may be programmed to extract the seismic orientation data derived from the structure tensor, and apply the seismic orientation data to the Kirchhoff migration process. A seismic depth image may then be generated based on the Kirchhoff migration process as constrained by the structure tensor, as at 210. More particularly, the computer 118 may be configured to generate a 3D seismic image of the subsurface geological features 102 based on Kirchhoff migration constrained by the structure tensor. The resulting seismic depth image will provide a well operator with a clearer and more accurate view of the subsurface geological features 102, as compared to other migration techniques.

To facilitate a better understanding of the present disclosure, and to provide validating evidence in support of the foregoing method 200, the following example is given. In no way should the following example be read to limit, or to define, the scope of the disclosure.

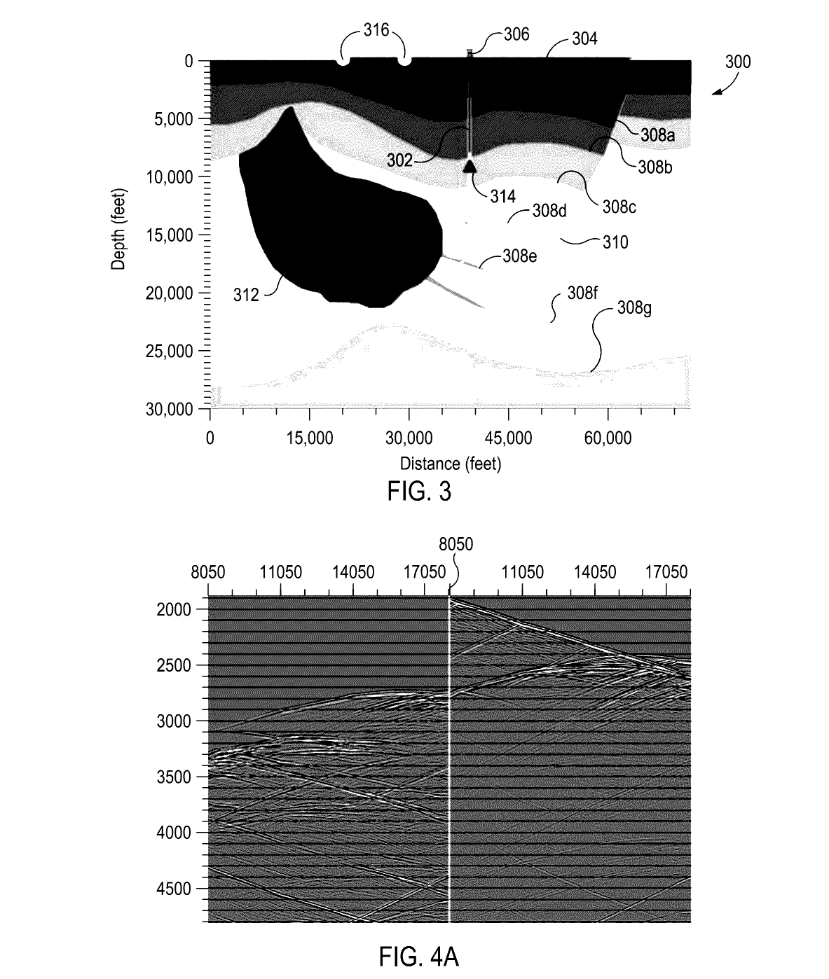

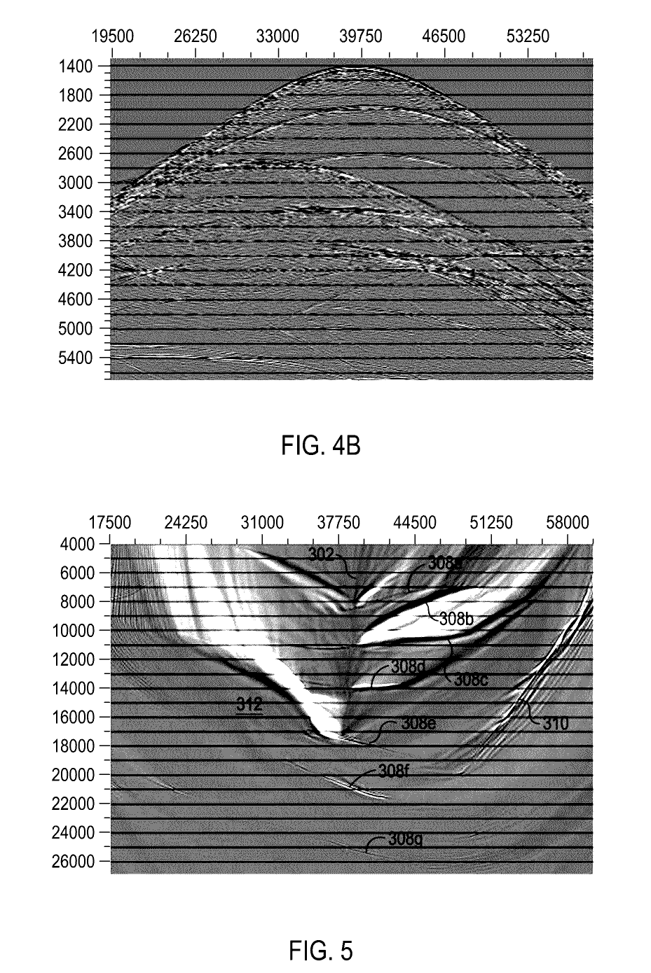

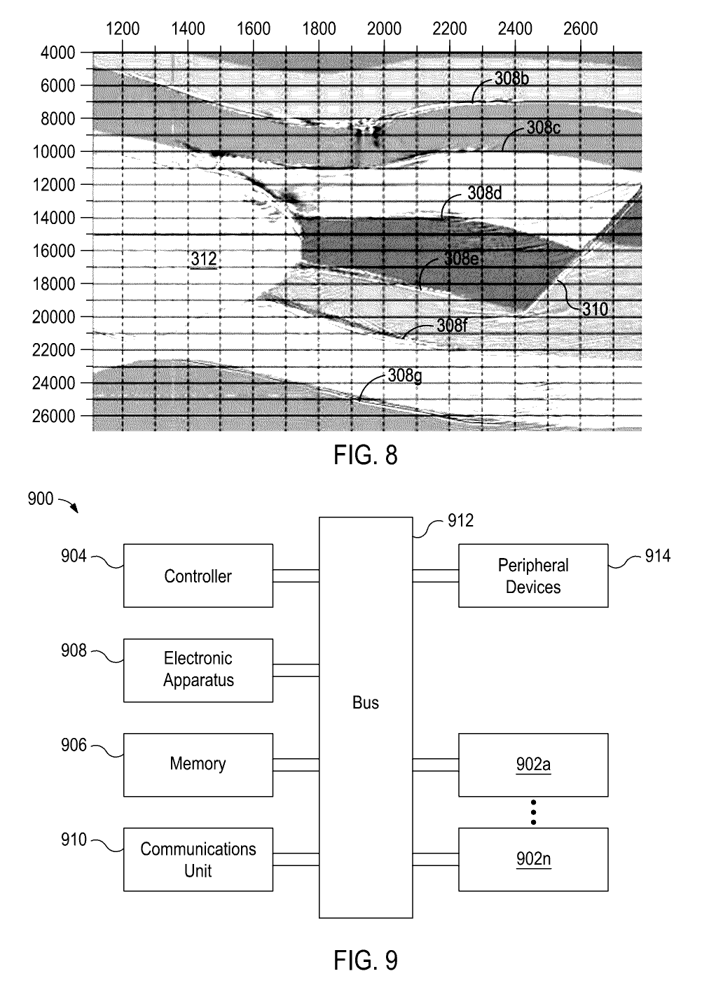

The structure dip constrained Kirchhoff migration method generally described herein was tested and verified on the HESS salt model 300, which is shown in FIG. 3. The data shown in FIG. 3, and used in FIGS. 4A, 4B, and 8 are provided courtesy of HESS (HESS Corporation of Dallas Tex.) and HESS is the source and owner of the data. The HESS salt model 300 constitutes a 3D velocity model, as generally described above, and includes synthetic velocity data corresponding to a particular geological formation or region. More particularly, the HESS salt model 300 is a 3D isotropic velocity model provided by the Hess Corporation for research and testing purposes. Researchers and engineers often use the HESS salt model 300 to validate and test theories related to VSP. As illustrated, the HESS salt model 300 includes a borehole 302 extending from a surface 304 where a wellhead installation 306 is located. The HESS salt model 300 also provides various subsurface geological features, such as a plurality of sedimentary layers 308 (shown as sedimentary layers 308a, 308b, 308c, 308d, 308e, 308f and 308g), a steeply dipping fault line 310, and a salt body 312. Each of the aforementioned subsurface geological features may be equivalent to the subsurface geological features 102 of FIG. 1.

The borehole 302 is depicted as a slightly deviated borehole. Two hundred downhole receivers 314 are placed in the borehole 302 and two hundred and eighty-six seismic sources 316 or “shots” are arranged on the surface 304. The X-axis for the HESS salt model 300 represents distance (in feet) and the Y-axis provides depth (in feet).

Finite difference modeling was used to compute the synthetic velocity data derived from the receivers 314 (FIG. 3) for this testing. FIGS. 4A and 4B show example shot gathers and receiver gathers, respectively, from the finite difference synthetic modeling. The line through the middle of the shot gathers plot of FIG. 4A delineates a separation between the two shots. FIG. 4B shows an example of a synthetic receiver gather for all the shots on the surface 304 (FIG. 3). For each surface shot, a seismic signal is sent to the receivers 314. In each of FIGS. 4A and 4B, the Y-axis provides depth (in feet) and the X-axis is indicative of the horizontal distance (in feet) from the borehole 302 (FIG. 3), but could also refer to the shot number.

To verify if all seismic structure related signals were simulated in the synthetic data, a full aperture migration was conducted. More particularly, Kirchhoff migration was applied to the synthetic data and the plot in FIG. 5 was thereby generated. As shown in FIG. 5, despite the strong migration swings caused by the survey geometry and lack of stacking power, near borehole bed boundaries can be seen in the open aperture seismic image. For instance, the sedimentary layers 308a-g may be generally perceived and the fault line 310 may be seen far away from the borehole 302. A portion of the salt body 312 is also perceivable in the seismic image of FIG. 5. However, it is difficult to isolate and stack only the structure-related signals with conventional Kirchhoff migration parameters. As seen in FIG. 5, the open aperture Kirchhoff migration contains a significant amount of migration noise. To limit or otherwise remove some of the migration noise, the aperture may be limited, such as by applying aperture limiting, global dip filtering, source and receiver weightings, etc.

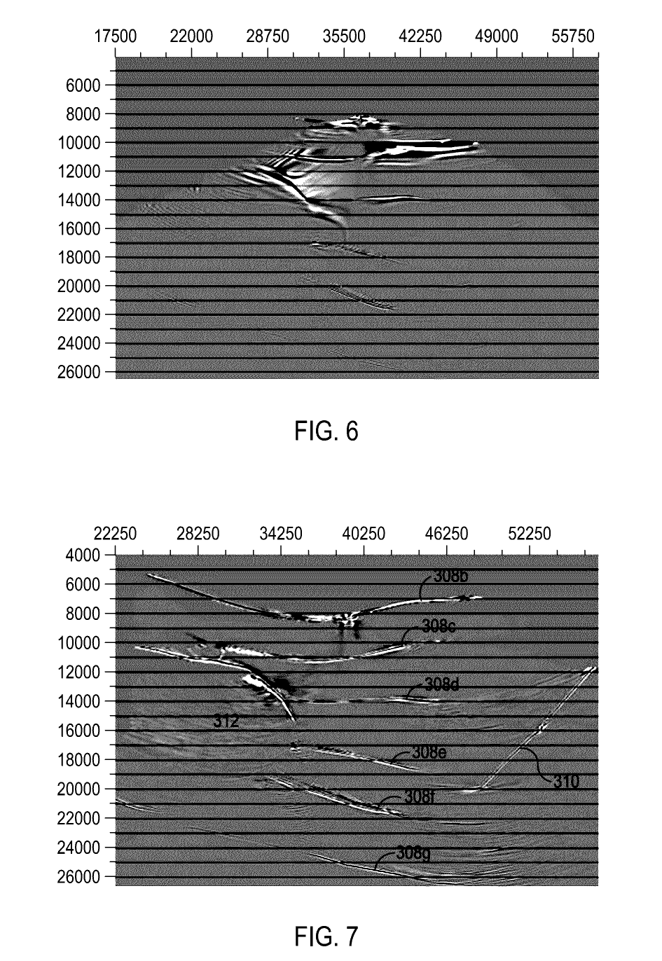

In FIG. 6, a seismic depth image result is depicted, and results from using Kirchhoff migration with a conventional aperture limiting technique. As seen in FIG. 6, only a few major sedimentary layers 308a-g (FIG. 3) near the borehole 302 (FIG. 3) were imaged. Accordingly, while some of the migration noise was removed through the aperture limiting technique, the shape and location of several of the subsurface geological features were changed. For instance, there are some subsurface geological features depicted in FIG. 6 that are not readily correlated to any of the subsurface geological features of the HESS salt model 300 of FIG. 3. Consequently, the aperture limiting technique does not appear to be accurate and otherwise provides a false reading.

By incorporating the structure dip information computed from the structure tensors described herein into the Kirchhoff migration, however, a new seismic image was obtained, as shown in FIG. 7. FIG. 7 shows raw Kirchhoff migration image with structure tensor constraint. The image shows the boundaries of the major sedimentary layers 308b-g near and extending away from the borehole 302 (FIG. 3). As can be seen, the sedimentary layers 308d, 308e, and 308f properly terminate at the boundary for the salt body 312. Moreover, the dipping fault line 310 in the far borehole region is also well imaged. In FIG. 8, the seismic image generated in FIG. 7 is shown overlaid with the HESS salt model 300 of FIG. 3. Overlaying the seismic image of FIG. 7 with the velocity model of the HESS salt model 300 of FIG. 3 confirms the validity of the seismic image result. As can be seen, the new seismic image quality of FIG. 7 is greatly improved as compared to the raw Kirchhoff migration seismic image of FIG. 5 or the Kirchhoff migration seismic image of FIG. 6 which applied aperture limiting techniques.

The result of this test provides verification that VSP image quality can be improved by combining structure information from structure tensor analysis. By incorporating structure dip information in the migration process (e.g., Kirchhoff migration), the borehole seismic data are coherently stacked in a favorably angular region around given subsurface geological structures, thereby reducing the noise and migration artifacts and enhancing the seismic image quality.

Referring now to FIG. 9, illustrated is a block diagram of features of an exemplary computer system 900 that may be used to process seismic input data and generate an output for user consideration, according to one or more embodiments of the disclosure. In some embodiments, the computer system 900 may comprise or otherwise be compatible with the seismic data processing platform SEISSPACE® and PROMAX®, available from Landmark Graphics of Halliburton Energy Services.

The system 900 may include various inputs 902a . . . 902n where seismic input data may be obtained from one or more receivers 112 (FIG. 1). The system 900 may also include a controller 904, a memory 906, an electronic apparatus 908, and a communications unit 910. The controller 904, the memory 906, and the communications unit 910 may be arranged to operate as a processing unit to process the seismic input data as generally described above. The controller 904, the memory 906, and the electronic apparatus 908 may be configured to control the activation of receivers 112 (FIG. 1) and thereby control the inputs 902a-n. The communications unit 910 may facilitate downhole communication with the receivers 112. Such downhole communications can include a telemetry system, for example. The communications unit 910 can further include communications operable among land locations, sea surface locations both fixed and mobile, and undersea locations both fixed and mobile. The communications unit 910 may use combinations of wired communication technologies and wireless technologies at frequencies that do not interfere with on-going measurements.

The system 900 may also include a bus 912 that provides electrical conductivity among the components of the system 900. The bus 912 can include an address bus, a data bus, and a control bus, each independently configured. The bus 912 may use a number of different communication mediums that allow for the distribution of components of the system 900. Use of the bus 912 can be regulated by the controller 904. In an embodiment, the controller 904 may encompass a processor or a group of processors that may operate independently depending on an assigned function. In various embodiments, one or more peripheral devices 914 may include displays, additional storage memory, and/or other control devices that may operate in conjunction with the controller 904 and/or the memory 906 to provide a visual output to a user. In some embodiments, the peripheral devices 914 may provide a graphical user interface where the user can view and otherwise manipulate the seismic input data and resulting seismic images.

The various embodiments herein are directed to computer control and include various methods and algorithms that can be implemented using computer hardware, software, combinations thereof, and the like. To illustrate the interchangeability of hardware and software, various illustrative methods and algorithms have been described generally in terms of their functionality. Whether such functionality is implemented as hardware or software will depend upon the particular application and any imposed design constraints. For at least this reason, it is to be recognized that one of ordinary skill in the art can implement the described functionality in a variety of ways for a particular application.

Computer hardware used to implement the various illustrative blocks, modules, elements, components, methods, and algorithms described herein can include a processor configured to execute one or more sequences of instructions, programming stances, or code stored on a non-transitory, computer-readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory (e.g., random access memory (RAM), flash memory, read only memory (ROM), programmable read only memory (PROM), erasable read only memory (EPROM)), registers, hard disks, removable disks, CD-ROMs, DVDs, or any other like suitable storage device or medium.

Executable sequences described herein can be implemented with one or more sequences of code contained in a memory, such as the memory 906. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM, and flash EPROM.

Embodiments disclosed herein include:

A. A method that includes acquiring seismic input data, computing a structure tensor based on the seismic input data to determine seismic orientation data for one or more subsurface geological features, applying Kirchhoff migration to the seismic input data, constraining the Kirchhoff migration with the seismic orientation data derived from the structure tensor, and generating a seismic depth image based on the Kirchhoff migration as constrained by the structure tensor.

B. A well system that includes one or more seismic sources arranged on a surface to impart seismic energy into one or more subsurface geological features one or more receivers arranged within a borehole extending from the surface to detect the seismic energy as reflected off the one or more subsurface geological features, wherein the one or more receivers generate seismic data input based on the seismic energy reflected off the one or more subsurface geological features, a computer arranged to receive the seismic data input from the one or more receivers and including a non-transitory, computer readable medium programmed with computer executable instructions that, when executed by a processor of the computer, perform a method comprising computing a structure tensor based on the seismic input data to determine seismic orientation data for the one or more subsurface geological features, applying Kirchhoff migration to the seismic input data, constraining the Kirchhoff migration with the seismic orientation data derived from the structure tensor, and generating a seismic depth image based on the Kirchhoff migration as constrained by the structure tensor.

Each of embodiments A and B may have one or more of the following additional elements in any combination: Element 1: wherein the seismic input data comprises a stacked seismic image volume obtained by generating one or more seismic signals using one or more seismic sources positioned on a surface location, the one or more seismic signals propagating into the one or more subsurface geological features below the surface location, detecting the one or more seismic signals with one or more receivers arranged within a borehole, generating one or more output signals with the one or more receivers, receiving the one or more output signals with a computer, and processing the one or more output signals with the computer to obtain the seismic input data. Element 2: wherein processing the one or more output signals with the computer comprises generating with the computer multiple shot gathers and receiver gathers from the one or more output signals, and stacking the multiple shot gathers and receiver gathers to produce a three-dimensional image of the one or more subsurface geological features. Element 3: further comprising conveying the one or more receivers into the borehole on a wireline. Element 4: further comprising conveying the one or more receivers into the borehole while drilling the borehole. Element 5: wherein the seismic input data comprises a three-dimensional velocity model including synthetic seismic data. Element 6: wherein computing the structure tensor based on the seismic input data comprises receiving the seismic input data with a computer, determining eigenvalues and eigenvectors of the structure tensor with the computer. Element 7: further comprising undertaking Gaussian convolution of the eigenvalues and the eigenvectors of the structure tensor with the computer to obtain smoothed Gaussian derivatives of the seismic input data. Element 8: wherein applying Kirchhoff migration to the seismic input data comprises receiving the seismic input data with a computer, and back-propagating the seismic input data to provide a seismic image representative of the one or more subsurface geological features. Element 9: wherein constraining the Kirchhoff migration with the seismic orientation data derived from the structure tensor comprises extracting the seismic orientation data derived from the structure tensor, and applying the seismic orientation data to the Kirchhoff migration processing.

Element 10: wherein the one or more seismic sources are selected from the group consisting of an explosive, a vibration-generating machine, an air gun, and a marine vibrator. Element 11: wherein processing the one or more output signals with the computer comprises generating with the computer multiple shot gathers and receiver gathers from the one or more output signals, and stacking the multiple shot gathers and receiver gathers to produce a three-dimensional image of the one or more subsurface geological features. Element 12: wherein the one or more receivers are conveyed into the borehole on a wireline. Element 13: wherein the one or more receivers are conveyed into the borehole while the borehole is drilled. Element 14: wherein the computer determines eigenvalues and eigenvectors of the structure tensor in computing the structure tensor based on the seismic input data. Element 15: wherein applying Kirchhoff migration to the seismic input data comprises back-propagating the seismic input data to provide a seismic image representative of the one or more subsurface geological features. Element 16: wherein constraining the Kirchhoff migration with the seismic orientation data derived from the structure tensor comprises extracting the seismic orientation data derived from the structure tensor, and applying the seismic orientation data to the Kirchhoff migration processing.

By way of non-limiting example, exemplary combinations applicable to A, B, and C include: Element 1 with Element 2; Element 1 with Element 3; Element 1 with Element 4; and Element 6 with Element 7.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

1. A method, comprising:
acquiring seismic input data;
computing a structure tensor based on the seismic input data to determine seismic orientation data for one or more subsurface geological features;
applying Kirchhoff migration to the seismic input data;
constraining the Kirchhoff migration with the seismic orientation data derived from the structure tensor; and
generating a seismic depth image based on the Kirchhoff migration as constrained by the structure tensor.

2. The method of claim 1, wherein the seismic input data comprises a stacked seismic image volume obtained by:
generating one or more seismic signals using one or more seismic sources positioned on a surface location, the one or more seismic signals propagating into the one or more subsurface geological features below the surface location;
detecting the one or more seismic signals with one or more receivers arranged within a borehole;
generating one or more output signals with the one or more receivers;
receiving the one or more output signals with a computer; and
processing the one or more output signals with the computer to obtain the seismic input data.

3. The method of claim 2, wherein processing the one or more output signals with the computer comprises:
generating with the computer multiple shot gathers and receiver gathers from the one or more output signals; and
stacking the multiple shot gathers and receiver gathers to produce a three-dimensional image of the one or more subsurface geological features.

4. The method of claim 2, further comprising conveying the one or more receivers into the borehole on a wireline.

5. The method of claim 2, further comprising conveying the one or more receivers into the borehole while drilling the borehole.

6. The method of claim 1, wherein the seismic input data comprises a three-dimensional velocity model including synthetic seismic data.

7. The method of claim 1, wherein computing the structure tensor based on the seismic input data comprises:
receiving the seismic input data with a computer; and
determining eigenvalues and eigenvectors of the structure tensor with the computer.

8. The method of claim 7, further comprising undertaking Gaussian convolution of the eigenvalues and the eigenvectors of the structure tensor with the computer to obtain smoothed Gaussian derivatives of the seismic input data.

9. The method of claim 1, wherein applying Kirchhoff migration to the seismic input data comprises:
receiving the seismic input data with a computer; and
back-propagating the seismic input data to provide a seismic image representative of the one or more subsurface geological features.

10. The method of claim 1, wherein constraining the Kirchhoff migration with the seismic orientation data derived from the structure tensor comprises:
extracting the seismic orientation data derived from the structure tensor; and
applying the seismic orientation data to the Kirchhoff migration processing.

11. The method of claim 10, wherein the seismic orientation data is subjected to Gaussian convolution to yield a smoothed structure tensor and wherein the smoothed structure tensor is subjected to eigenanalysis to determine the eigenvalues and eigenvectors using an eigenvalue threshold to eliminate low-amplitude non-coherent noises.

12. A well system, comprising:
one or more seismic sources arranged on a surface to impart seismic energy into one or more subsurface geological features;
one or more receivers arranged within a borehole extending from the surface to detect the seismic energy as reflected off the one or more subsurface geological features, wherein the one or more receivers generate seismic data input based on the seismic energy reflected off the one or more subsurface geological features;
a computer arranged to receive the seismic data input from the one or more receivers and including a non-transitory, computer readable medium programmed with computer executable instructions that, when executed by a processor of the computer, perform a method comprising:
computing a structure tensor based on the seismic input data to determine seismic orientation data for the one or more subsurface geological features;
applying Kirchhoff migration to the seismic input data;
constraining the Kirchhoff migration with the seismic orientation data derived from the structure tensor; and
generating a seismic depth image based on the Kirchhoff migration as constrained by the structure tensor.

13. The well system of claim 12, wherein the seismic data input comprises a stacked seismic image volume obtained by:
generating one or more seismic signals using one or more seismic sources positioned on a surface location, the one or more seismic signals propagating into the one or more subsurface geological features below the surface location;
detecting the one or more seismic signals with one or more receivers arranged within a borehole;
generating one or more output signals with the one or more receivers;
receiving the one or more output signals with a computer; and
processing the one or more output signals with the computer to obtain the seismic input data.

14. The well system of claim 12, wherein the one or more seismic sources are selected from the group consisting of an explosive, a vibration-generating machine, an air gun, and a marine vibrator.

15. The well system of claim 13, wherein processing the one or more output signals with the computer comprises:
generating with the computer multiple shot gathers and receiver gathers from the one or more output signals; and
stacking the multiple shot gathers and receiver gathers to produce a three-dimensional image of the one or more subsurface geological features.

16. The well system of claim 12, wherein the one or more receivers are conveyed into the borehole on a wireline.

17. The well system of claim 12, wherein the one or more receivers are conveyed into the borehole while the borehole is drilled.

18. The well system of claim 12, wherein computing the structure tensor based on the seismic input data comprises determining eigenvalues and eigenvectors of the structure tensor.

19. The well system of claim 12, wherein applying Kirchhoff migration to the seismic input data comprises back-propagating the seismic input data to provide a seismic image representative of the one or more subsurface geological features.

20. The well system of claim 12, wherein
constraining the Kirchhoff migration with the seismic orientation data derived from the structure tensor comprises:
extracting the seismic orientation data derived from the structure tensor; and
applying the seismic orientation data to the Kirchhoff migration processing.

21. The method of claim 21, wherein the seismic orientation data is subjected to Gaussian convolution to yield a smoothed structure tensor and wherein the smoothed structure tensor is subjected to eigenanalysis to determine the eigenvalues and eigenvectors using an eigenvalue threshold to eliminate low-amplitude non-coherent noises.
